(19) United States
(12) Patent Application Publication
(10) Pub. No.: US 2023/0312841 A1
(43) Pub. Date: Oct. 5, 2023

(54) POWDER COMPOSITION FOR ADDITIVE PROCESS AND PRINTED PARTS THEREOF

(71) Applicant: SETUP Performance SAS, Frontonas (FR)

(72) Inventors: Florian A. DEME, Frontonas (FR); Jérôme GIMENEZ, Frontonas (FR); Maria Del Carmen QUEROL ESPARCH, San Cugat Del Valles (ES); Laurent Jacques Robert HERSCHKE, San Cugat Del Valles (ES)

(21) Appl. No.: 18/023,744

(22) PCT Filed: Aug. 30, 2021
(86) PCT No.: PCT/EP2021/073890

§ 371 Date: Feb. 28, 2023

(30) Foreign Application Priority Data
Aug. 31, 2020 (EP) 20305963.9

(51) Int. Cl. C08J 3/12; B33Y 70/00; B33Y 10/00; C08K 3/22; C08K 3/36

(52) U.S. Cl. CPC C08J 3/126; B33Y 70/00; B33Y 10/00; C08K 3/22; C08K 3/36; C08J 2323/08; C08J 2323/14; C08K 2201/011; C08K 2003/2227

(57) ABSTRACT

The present invention relates to a powder composition I comprising nanoparticles A blended with a polyolefinic powder II, said polyolefinic powder II containing particles B embedded in a polyolefinic matrix C, nanoparticles A being metal or metal oxide nanoparticles and particles B being metal, nitride, carbide or metal oxide micro or nanoparticles, said powder composition I containing at least 90 wt % of polyolefinic matrix C relative to the total weight of the powder composition I. The invention further relates to the preparation of said powder composition I and its use in an additive process for the preparation of a 3D printed article.

The invention relates to a powder composition that may be used in an additive process for the preparation of a three-dimensional article. According to the invention, the powder composition comprises nanoparticles blended with a polyolefinic powder, said polyolefinic powder containing particles embedded in polyolefinic matrix. The nanoparticles are metal or metal oxide nanoparticles and the particles are metal, nitride, carbide or metal oxide micro or nanoparticles.

A turning point has been reached in the last few years with the emergence of three-dimensional (3D) printing techniques allowing the production of custom and low-cost 3D articles. Using such technique, the 3D article is produced layer by layer. For this purpose, by means of upstream computer-aided design software (CAD), the 3D structure of the 3D article to be obtained is divided up into slices. The 3D article is then created by laying down successive slices or layers of material until the entire 3D article is produced. In other words, the slices are produced one by one in the form of layers, by carrying out the following binary sequence repeatedly:
depositing a layer of the material necessary for producing the desired article on a platform or on an existing consolidated layer, followed by
agglomerating said layer and bonding said layer to the precedent if present in accordance with the predefined pattern.

Thus, the 3D article is constructed by superposing elementary layers that are bonded one to another.

Conventional 3D printing processes are limited to particular types of materials. These materials should be resistant to heat (i.e. no degradation should occur upon heating during the additive process), to moisture, to radiation and to weathering, and should have a slow solidification time. Importantly, the slices or layers should adhere to one another in order to produce a 3D article with satisfactory mechanical strength that will not collapse. Ideally, the material should also have a low melting temperature and an appropriate viscosity or flowability.

Importantly, after the additive process, the obtained 3D articles should have the desired properties such as mechanical properties, and should be of the exact desired dimensions and shape.

The material is usually composed of polymer(s) in combination with additives that are used to tailor the properties of the material and of the resulting 3D articles. For example, dyes, fillers, antistatic agents, anti-nucleating agents, viscosity agents or flowing aids are commonly added. Fillers are very important as they have an impact on both thermal and electric conductivity. Thermal conductivity is of importance in the additive process, whereas electric conductivity may be important with respect to the desired properties of the final 3D article. In the case where the material is a powder, flowing aids enhance the flowability of the powder, which is a key parameter of the additive process in this case.

During the additive process, a portion of the deposited layer is not agglomerated, depending on the predefined pattern. It is desirable to reuse this non-agglomerated material for the preparation of another 3D article.

Another issue is the cost of these materials. Indeed, these materials may be expensive. To this end, research has focused on cheaper materials. Work has been carried out both on polymers and on additives.

Polyamides (e.g. PA 12) are commonly used in additive processes such as SLS. Good results have been achieved with these polymers but they are quite expensive. Therefore, it is desirable to use cheaper polymers. In this context polyolefins are attractive since they are cheap, exhibit electrical insulation properties, and are chemical and heat resistant. However, they usually have a moderate flowability, a slow cooling cycle time, a moderate mechanical performance, and also a lower thermal conductivity and a lower thermal diffusivity compared to polyamides. The processing window of polyolefins is also narrower than the one of polyamides due to the appearance of multiple crystalline phases making more difficult to avoid the presence of raised parts while printing and/or having thermal bleed on the printed parts. Some research has been focused on polyethylene and/or polypropylene, as detailed for example in patent applications CN 106832905, CN 107825621, CN 107304261, and CN 1382572. Patent application CN 110157101 describes the use of random polypropylene copolymer, without any details on this copolymer.

Another option to provide cheaper materials for use in additive processes is to reduce the amount of additives and/or use cheaper additives.

Therefore, there is a need for a material for use in an additive process having the above mentioned properties (e.g. resistance to heat, to moisture, to radiation, to weathering, having good mechanical properties such as mechanical strength, low melting temperature and slow solidification time, and having good flowability and good thermal conductivity) that is not too expensive.

Advantageously, the processing window is wide. Importantly, the material should afford 3D articles with the expected dimensions and shape, and with the desired physico chemical properties. Advantageously, the non-agglomerated material may be reused for the preparation of other 3D articles.

In this context, the Applicant has solved the above mentioned problem by providing a powder composition comprising nanoparticles blended with a polyolefinic powder, said polyolefinic powder containing particles embedded in a polyolefinic matrix, the nanoparticles being metal or metal oxide nanoparticles and the particles being metal, nitride, carbide or metal oxide micro or nanoparticles, said powder composition containing at least 90 wt % of polyolefinic matrix relative to the total weight of the powder composition. According to an embodiment, the polyolefinic matrix is a copolymer of polyethylene or polypropylene with 1 wt % to 8 wt % of ethylene or 1-butene relative to the total weight of the polyolefinic matrix, and preferably the polyolefinic matrix is a copolymer of polypropylene with 1 wt % to 8 wt % of ethylene relative to the total weight of the polyolefinic matrix.

The powder composition according to the invention may have further one or more of the following characteristics:
the particles are present in an amount ranging from 0.2 wt % to 9 wt % relative to the total weight of the powder composition;
the nanoparticles are present in an amount ranging from 0.05 wt % to 0.5 wt % relative to the total weight of the powder composition;
the nanoparticles contain aluminium oxide, zinc oxide, silicon dioxide, copper oxide, titanium dioxide, or silver;
the particles contain aluminium oxide, aluminium nitride, zinc oxide, silicon dioxide, silicon carbide, boron nitride, iron carbide, copper oxide, titanium dioxide, or silver;
the nanoparticles and the particles are the same;
the polyolefinic matrix contains polyethylene, polypropylene, polybutene-1, polymethylpentene, polyoctene, polyisoprene, polybutadiene, a copolymer thereof or a blend of at least two of these polyolefins;
the polyolefinic matrix contains a copolymer of polyethylene, polypropylene, polybutene-1, polymethylpentene, polyoctene, polyisoprene, or polybutadiene with a C2-C12 alpha-alkylene; and
the powder composition further comprises anti-oxidants; fillers of different nature than particles and nanoparticles such as for example glass beads, fibers or mineral fillers; anti nucleating agents; co-crystallizers; plasticizers; dyes; antistatic agents; waxes; compatibilizers such as maleic anhydride grafted polymer powder; polymer powders other than the polyolefin such as polyamide or polyester powder.

The invention further relates to the preparation of the powder composition according to the invention. In the context of the invention, the powder composition is prepared according to the following steps:
a) providing a polyolefinic matrix, nanoparticles and particles, the nanoparticles being metal or metal oxide nanoparticles and the particles being metal, nitride, carbide or metal oxide micro or nanoparticles,
b) melting the polyolefinic matrix,
c) mixing the melted polyolefinic matrix with particles,
d) powdering the resulting mixture to obtain a polyolefinic powder in which the particles are embedded in the polyolefinic matrix,
e) mixing the nanoparticles with the polyolefinic powder,
f) sieving to obtain the powder composition.

According to an embodiment, the polyolefinic matrix is a copolymer of polyethylene or polypropylene with 1 wt % to 8 wt % of ethylene or 1-butene relative to the total weight of the polyolefinic matrix, and preferably the polyolefinic matrix is a copolymer of polypropylene with 1 wt % to 8 wt % of ethylene relative to the total weight of the polyolefinic matrix.

The process of preparing of the powder composition according to the invention may have one or more of the following characteristics:
anti-oxidants; fillers of different nature than the particles and the nanoparticles such as for example glass beads, fibers or mineral fillers; anti nucleating agent; co-crystallizers; polymers other than polyolefin such as polyester or polyamide; plasticizers; dyes; antistatic agents; waxes, compatibilizers such as maleic anhydride grafted polymer powder; and/or polymer powders such as polyamide or polyester powder are added at step c) and/or at step e), simultaneously or one after the other in any order;
at least one step g) is carried out after step d) and/or step e) and/or step f), said step g) being a step of oxidation, mechanical treatment, thermal treatment, surface coating, rounding particles, and/or air classification;
steps a) to c) are carried out in an extruder, preferably a tween-screw extruder; and
the polyolefinic matrix contains a copolymer of polyethylene, polypropylene, polybutene-1, polymethylpentene, polyoctene, polyisoprene, or polybutadiene with a C2-C12 alpha-alkylene.

The invention further relates to the use of the powder composition according to the invention, or the powder composition obtained from the process according to the invention, for the manufacture of a three-dimensional printed article.

The invention also relates to a 3D printed article made from the powder composition according to the invention, or made from the powder composition obtained with the process of preparation of a powder composition according to the invention.

Finally, the invention relates to a method for preparing a 3D printed article according to the invention using an additive process such as selective laser sintering (SLS) or multi-jet fusion (MJF) technique.

The invention will be further explained with reference to the annexed FIGURE.

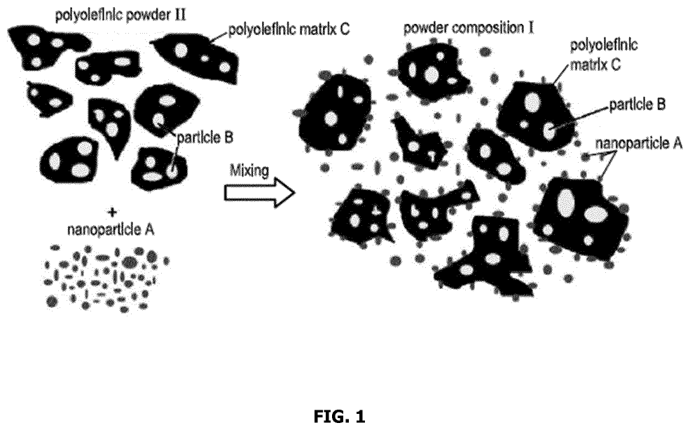

FIG. 1 is a schematic illustration of the powder composition according to the invention.

### POWDER COMPOSITION

As illustrated in FIG. 1, the powder composition, referenced as powder composition I in the following description of the invention, comprises a mixture or a dry blend of nanoparticles, referenced as nanoparticles A hereafter, with a polyolefinic powder II. In the present invention, the polyolefinic powder II comprises particles, named particles B hereafter, that are embedded in a polyolefinic matrix, referenced as polyolefinic matrix C hereafter. Optionally, the powder composition I comprises additives (additives are not illustrated in FIG. 1).

In the sense of the invention, “dry blend” is a mixture of dry components. The resulting mixture is not an intimate mixture of the components, but is homogeneous. In the context of the invention, the dry blend of polyolefinic powder II and nanoparticles A results in a coating of the surface of the grains constituting the polyolefinic powder II by nanoparticles A. This is illustrated in FIG. 1: nanoparticles A are not incorporated in the polyolefinic matrix C, but are surrounding the grains constituting the polyolefinic powder II.

In the sense of the invention, “particles B embedded in polyolefinic matrix C” means that particles B and the polyolefinic matrix C form an intimate mixture. In other words, the mixture of particles B and polyolefinic matrix C is homogeneous and the various components may not spontaneously separate from one another. Thus, the resulting polyolefinic powder II is a powder composed of a multitude of grains, each grain comprising a mixture of particles B and polyolefinic matrix C. This is illustrated in FIG. 1, where the grains of polyolefinic powder II (and also of powder composition I) comprises particles B incorporated in polyolefinic matrix C. The fact that particles B are embedded in the polyolefinic matrix C may be evidenced by microscopy, such as MEB optionally coupled with EDX (energy dispersive X-ray analysis).

In the context of the invention, “polyolefinic matrix” is mainly composed of polyolefin, and preferably comprises at least 75 wt % of a single polyolefin or of a mixture of polyolefins. The polyolefinic matrix may comprise additives as detailed hereafter. The polyolefinic matrix used is in solid form, e.g. as a powder or as pellets. Preferably, the polyolefinic matrix is used as pellets.

According to the invention, various polyolefinic matrix C may be used. Polyolefinic matrix C comprises, or preferably consists in, polyolefin(s). In the context of the invention, the polyolefin may be a homopolymer or a copolymer such as block copolymer or random copolymer.

The term “random” indicates that the comonomers of the polyolefin are randomly distributed within the polyolefin. Random copolymers are also named statistical copolymers. On the other hand, “block copolymers” are polymers made of blocks of homopolymers of different nature.

According to a first embodiment, the polyolefin is a homopolymer. In this case, the polyolefin may be chosen from polyethylene, polypropylene, polybutene-1, polymethylpentene, polyoctene, polyisoprene, polybutadiene or a blend of at least two of these polyolefins. Preferably, polyethylene or polypropylene is used. According to a particular embodiment, polypropylene is used.

According to a second embodiment, the polyolefin is a copolymer. In this case, the polyolefin is preferably a copolymer of polyethylene, polypropylene, polybutene-1, polymethylpentene, polyoctene, polyisoprene, polybutadiene, or a blend of at least two of these polyolefins with at least one comonomer chosen from C2-C12 alpha-alkylene. It is understood that said comonomer is different from the other monomer(s) of the polyolefin. As an example of comonomers, one can cite ethylene, propylene, 1-butene, 1-pentene, 1-hexene, 1-octene, and 4-methyl-1-pentene. Preferably, ethylene or 1-butene is used, even more preferably ethylene is used. According to a preferred embodiment, the polyolefin is a copolymer of polyethylene or polypropylene with ethylene or 1-butene, preferably the polyolefin is a copolymer of polypropylene with ethylene. According to this embodiment, said comonomer is preferably present in an amount ranging from 1 wt % to 8 wt %, preferably from 1.5 wt % to 4 wt % relative to the total weight of the polyolefinic matrix C. The amount of comonomer in the polyolefinic matrix may be determined by IR or ¹³C NMR.

According to a particular embodiment, the polyolefin is a copolymer of polyethylene, polypropylene, polybutene-1, polymethylpentene, polyoctene, polyisoprene, polybutadiene, or a blend of at least two of these polyolefins with at least one first comonomer chosen from C2-C12 alpha-alkylene and with at least a second comonomer, said second comonomer not being an alkene.

According to this particular embodiment, the polyolefin is preferably a copolymer of polyethylene, polypropylene, polybutene-1, polymethylpentene, polyoctene, polyisoprene, polybutadiene, or a blend of at least two of these polyolefins with at least one first comonomer chosen from C2-C12 alpha-alkylene, and a second comonomer not being an alkene. It is understood that said comonomers are different from the other monomer(s) of the polyolefin. As an example of first comonomers, one can cite ethylene, propylene, 1-butene, 1-pentene, 1-hexene, 1-octene, and 4-methyl-1-pentene. Preferably, ethylene or 1-butene is used as first comonomer, even more preferably ethylene is used. The second comonomer may be for example chosen from maleic anhydride, glycidyl methacrylate, acrylic acid, vinyl acrylate, butyl acrylate, methyl acrylate, methyl methacrylate and methacrylic acid, or a combination thereof. According to this embodiment, the second comonomer may be either included in the chain of the polyolefin copolymer (meaning that the copolymer is linear) or grafted on the polyolefinic chain. According to a preferred embodiment, the polyolefin is a copolymer of polyethylene or polypropylene with ethylene or 1-butene and with maleic anhydride or glycidyl methacrylate, preferably the polyolefin is a copolymer of polypropylene with ethylene and with maleic anhydride or glycidyl methacrylate. According to this particular embodiment, the first comonomer is preferably present in an amount ranging from 1 wt % to 8 wt %, and the second comonomer is preferably present in an amount ranging from 0.3 wt % to 5 wt %, relative to the total weight of the polyolefinic matrix C.

The molecular weight distribution is defined as Mw/Mn, with Mw representing the weight average molecular weight and Mn representing the number average molecular weight. Molecular weight can be determined by size exclusion chromatography or gel permeation chromatography. According to the invention, the polyolefin has a molecular weight distribution ranging from 2 to 5, preferably from 2.1 to 4 and even more preferably from 2.2 to 3.5.

According to an embodiment, the polyolefin used has a melt flow index ranging from 1 g/10 min to 40 g/10 min, preferably from 3 g/10 min to 30 g/10 min, more preferably ranging from 5 g/10 min to 15 g/10 min, at a temperature of 230° C. and under a load of 2.16 kg. The melt flow index is determined according to ISO 1133:2005 standard.

In order to be successfully used in an additive process, the polyolefin preferably has specific thermal properties. Advantageously, its melting peak temperature Tₘ is at least 20° C. higher than its crystallization temperature T_{c}. Advantageously, its melting peak temperature Tₘ is at most 10° C. higher than its onset melting temperature T_{m onset}. Advantageously, its start melt temperature T_{m start} is at least higher than the onset crystallization temperature T_{c onset}. The melting peak temperature Tₘ, the crystallization temperature T_{c}, the onset melting temperature T_{m onset}, and the start melt temperature T_{m start} may be determined by differential scanning calorimetry (DSC) usually at ±10° C./min.

The melting peak temperature Tₘ corresponds to the temperature measured at the maximum of the peak of the thermal phenomenon corresponding to melting. The start melt temperature T_{m start} corresponds to the start of the phenomenon of melting of the crystallites, i.e. when the first crystallites start to melt. The onset value corresponds to an extrapolated temperature corresponding to the intersection of the base line of the peak and of the tangent to the point with the largest slope of the first portion of the melting peak for temperatures below the maximum temperature for the peak. The onset of crystallization is determined with the same graphical method during the cooling phase. The crystallization temperature corresponds to the temperature measured at the maximum of the peak of the thermal phenomenon corresponding to crystallization.

In a particular embodiment, the polyolefin has a melting peak temperature Tₘ from about 70° C. to about 250° C. In another embodiment, the polyolefin has a melting peak temperature Tₘ from about 110° C. to about 180° C.

Advantageously, the processing window (i.e. the gap between the onset of the crystallisation peak and the onset of the melting peak) is advantageously of at least 15° C., more advantageously of at least 20° C. and even more advantageously of at least 30° C.

Advantageously, polyolefinic matrix C is present in an amount ranging from 92 wt % to 99.9 wt %, preferably from 95 wt % to 99.5 wt %, even more preferably 97 wt % to 99 wt % relative to the total weight of the polyolefinic powder II.

According to the invention, polyolefinic matrix C is present in an amount of at least 90 wt % relative to the total weight of the powder composition I, and preferably ranging from 91 wt % to 99.5 wt %, more preferably from 95 wt % to 99 wt %. This may be measured by ATG for example.

According to the invention, the polyolefinic powder II comprises particles B compounded with the polyolefinic matrix C such that they form an intimate mixture.

According to a first embodiment, the polyolefinic powder II comprises only one type of particles B, meaning that all the particles B contained in the polyolefinic powder II are identical and that the polyolefinic powder II comprises only one kind of particle corresponding to particles B.

According to a second embodiment, the polyolefinic powder II comprises more than one type of particles B. In other words, according to this embodiment, the polyolefinic powder II comprises at least two particles B of different chemical nature and/or different size and/or different shape.

Particles B may be microparticles or nanoparticles.

In the context of the invention, “nanoparticles” refer to particles of nanometric elementary size, i.e. of elementary size of at least 1 nm and no more than 100 nm. By “elementary size”, it is meant the highest dimension of the nanoparticle.

In the context of the invention, “microparticles” refer to particles of micrometric elementary size, i.e. of elementary size of at least 1 μm and no more than 100 μm.

According to the invention, particles B are chosen from metal particles, nitride particles, carbide particles or metal oxide particles. In the context of the invention, particles B may comprise, or consist of, metal, nitride, carbide, metal oxide.

As examples of metallic particles B (also referred as metal particles B), silver particles, copper particles and aluminium particles may be cited. A preferred metallic particle B is silver particle.

As examples of nitride particles B, aluminium nitride particles and boron nitride particles may be cited.

As examples of carbide particles B, silicon carbide particles and iron carbide particles may be cited.

As examples of metal oxide particles B, aluminium oxide particles, zinc oxide particles, magnesium oxide particles, silicon dioxide particles, copper oxide particles and titanium dioxide particles may be cited. A particularly preferred metal oxide particle B is aluminium oxide B.

According to a preferred embodiment, particles B contain aluminium oxide, aluminium nitride, zinc oxide, silicon dioxide, silicon carbide, boron nitride, iron carbide, copper oxide, titanium dioxide, or silver. In a particular embodiment, particles B are chosen from aluminium oxide, aluminium nitride, zinc oxide, silicon dioxide, silicon carbide, boron nitride, iron carbide, copper oxide, titanium dioxide, or silver. The choice of particles B may be driven by the desired properties of the powder composition I and/or of the three-dimensional printed article obtained from the powder composition I.

According to a preferred embodiment, particles B are metal oxide particles, preferably chosen from aluminium oxide or zinc oxide particles, or chosen from nitride particles preferably aluminum nitride particles.

Advantageously, particles B are present in the polyolefinic powder II in an amount ranging from 0.2 wt % to 10 wt %, preferably from 0.5 wt % to 5 wt %, more preferably from 1 wt % to 2 wt %, relative to the total weight of the polyolefinic powder II.

Advantageously, particles B are present in the powder composition I in an amount ranging from 0.2 wt % to 9 wt %, preferably from 0.5 wt % to 5 wt %, relative to the total weight of the powder composition I.

According to an embodiment, the polyolefinic powder II comprises one or more additives, preferably in an amount of no more than 20 wt %, more preferably in an amount ranging from 0.5 wt % to 16 wt %, relative to the total weight of the polyolefinic powder II. These additives may be introduced within the polyolefinic matrix C (before the introduction of particles B) or added to the mixture of polyolefinic matrix C and particles B prior to the mixing step. As a result, these additives are embedded in the polyolefinic powder II. These additives may be for example chosen from anti-oxidants, fillers (of different nature than particles B and nanoparticles A), anti nucleating agents, co-crystallizers, polymers other than polyolefin (polyester or polyamide for example), antistatic agents, plasticizers, or dyes.

According to a preferred embodiment, the polyolefinic powder II comprises the polyolefinic matrix C of which the polyolefin is chosen from homopolymers or copolymers of polyethylene, polypropylene, polybutene-1, polymethylpentene, polyoctene, polyisoprene, polybutadiene or a blend of at least two of these polyolefins, and particles B are chosen from particles containing metal, nitride, carbide, or metal oxide. Advantageously according to this embodiment, the polyolefinic matrix C is present in an amount ranging from 91 wt % to 99.5 wt %, and particles B are present in an amount ranging from 0.2 wt % to 9 wt % relative to the total weight of the powder composition I.

According to a preferred embodiment, the polyolefinic powder II comprises the polyolefinic matrix C of which the polyolefin is chosen from copolymers of polyethylene, polypropylene, polybutene-1, polymethylpentene, polyoctene, polyisoprene, or polybutadiene with at least one comonomer chosen from C2-C12 alpha-alkylene, and particles B are chosen from particles containing metal, nitride, carbide, or metal oxide. Advantageously according to this embodiment, the polyolefinic matrix C is present in an amount ranging from 91 wt % to 99.5 wt %, and particles B are present in an amount ranging from 0.2 wt % to 9 wt % relative to the total weight of the powder composition I.

According to a preferred embodiment, the polyolefinic powder II comprises the polyolefinic matrix C of which the polyolefin is chosen from copolymers of polyethylene or polypropylene with at least one comonomer chosen from C2-C12 alpha-alkylene, preferably ethylene or 1-butene, and particles B are chosen from particles containing metal oxide. Advantageously according to this embodiment, the polyolefinic matrix C is present in an amount ranging from 95 wt % to 99 wt %, and particles B are present in an amount ranging from 0.5 wt % to 5 wt % relative to the total weight of the powder composition I.

According to a preferred embodiment, the polyolefinic powder II comprises the polyolefinic matrix C of which the polyolefin is chosen from copolymers of polypropylene with ethylene, and particles B chosen from particles containing metal oxide such as aluminium oxide. Advantageously according to this embodiment, the polyolefinic matrix C is present in an amount ranging from 95 wt % to 99 wt %, and particles B are present in an amount ranging from 0.5 wt % to 5 wt % relative to the total weight of the powder composition I.

Particles B are used herein as filler. Particles B are important with respect to the thermal properties of the powder composition I. The Applicant has surprisingly discovered that the combined use of particles B and nanoparticles A, in much lower amounts compared to what is usually comprised in compositions for 3D printing, achieved satisfactory thermal conductivity and good flowability, as well as good mechanical properties.

Advantageously, the mean particle size d10 of the polyolefinic powder II ranges from 24 μm to 44 μm, preferably from 30 μm to 38 μm.

Advantageously, the mean particle size d50 of the polyolefinic powder II ranges from 50 μm to 75 μm, preferably from 55 μm to 70 μm.

Advantageously, the mean particle size d90 of the polyolefinic powder II ranges from 85 μm to 115 μm, preferably from 95 μm to 110 μm.

Advantageously, the mean particle size d99 of the polyolefinic powder II is at most 160 μm, preferably lower than 150 μm.

The mean particle sizes d10, d50, d90 and d99 are the mean sizes of particles (corresponding to the highest dimension of said particles) for which 10%, 50%, 90% and 99% by volume respectively of said particles have a lower size, as measured by dry laser granulometry technique (also known as laser diffraction granulometry). When the particle is spherical, the mean particle size d50 corresponds to the mean particle diameter d50.

According to the invention, the powder composition I also comprises at least one nanoparticles A. These nanoparticles A are not embedded in the polyolefinic matrix C, but mixed or dry blended with the polyolefinic powder II. Then, the powder composition I of the invention comprises a mixture or dry blend of nanoparticles A with an intimate mixture of polyolefinic matrix C and particles B (this intimate mixture being named polyolefinic powder II).

According to a first embodiment, the powder composition I comprises only one kind of nanoparticles A.

According to a second embodiment, the powder composition I comprises more than one kind of nanoparticles A. In other words, the powder composition I comprises at least two different nanoparticles A being of different chemical nature and/or different shape and/or different size.

According to the invention, nanoparticles A are metal or metal oxide nanoparticles. In the context of the invention, nanoparticles A may comprise, or consist of, metal or metal oxide.

Preferred nanoparticles A of metallic nature are silver nanoparticles.

Examples of metal oxide nanoparticles that may be used as nanoparticles A are aluminium oxide nanoparticles, zinc oxide nanoparticles, silicon dioxide nanoparticles, copper oxide nanoparticles, or titanium dioxide nanoparticles.

In a preferred embodiment, nanoparticles A are metal oxide nanoparticles.

In a particular embodiment, nanoparticles A are aluminium oxide nanoparticles.

In a particular embodiment, nanoparticles A and particles B are both metal oxide nanoparticles. According to this embodiment, nanoparticles A and particles B are preferably the same, meaning that they are identical in nature, in shape and in mean particle size (d10, d50, d90 and/or d99).

Advantageously, nanoparticles A are present in an amount ranging from 0.05 wt % to 0.5 wt % relative to the total weight of the powder composition I, preferably from 0.08 wt % to 0.3 wt %, and even more preferably 0.1 wt % to 0.2 wt %.

According to a preferred embodiment, nanoparticles A and particles B are present in amounts such that the weight ratio nanoparticles A/particles B ranges from 1/100 to ½, and preferably from 1/25 to ¼.

Nanoparticles A are used here as flow aids. Nanoparticles A enhance the flowability of the powder composition I due to their nano size. Additionally, the particular chemical nature of the nanoparticles A enhances the flowability of the powder composition I such that much lower amounts of flow aid(s) are required compared to what is commonly used in this technical field.

Advantageously, the nanoparticle A has a mean particle size (d10, d50, d90 and/or d99) smaller than the one of the polyolefinic composition II, and in particular 10 to 1000 times smaller. Advantageously, this affords a powder composition with improved flowability.

The powder composition I may comprise one or more additives, in addition to the ones eventually present in the polyolefinic powder II. These additives are not embedded in the polyolefinic matrix C or in any particles, but form a mixture or a dry blend with the other components of the powder composition I. Examples of these additives are glass beads or fibers, dyes, antistatic agents, waxes, mineral fillers, compatibilizers such as maleic anhydride grafted polymer powder, or polymer powder (such as for example polyamide or polyester powder), said polymer not being a polyolefin and said polymer powder having preferably the same or similar mean particle size (d10, d50, d90 and d99) than the powder composition I.

To summarize, the powder composition I may comprise additives embedded (i.e. present in the polyolefinic powder II) or not embedded (i.e. added with nanoparticles A) in the polyolefinic matrix C. As detailed above, these additives may be chosen from anti-oxidants, fillers (of different nature than particles B and nanoparticles A) such as for example glass beads, fibers or mineral fillers, anti nucleating agents, co-crystallizers, plasticizers, dyes, antistatic agents, waxes, compatibilizers such as maleic anhydride grafted polymer powder, and polymer powders other than polyolefin (as for example polyamide or polyester powder). When the powder composition I comprises one or more additives, they are preferably present in an amount of less than 20 wt %, preferably less than 10 wt % even more preferably less than 3% relative to the total weight of the powder composition I.

According to a first embodiment, the powder composition I does not comprise any additives other than the ones present in the polyolefinic powder II. In other words, according to this embodiment, the only additives that may be eventually present are embedded in the polyolefinic matrix C. According to this embodiment, the powder composition I has advantageously a mean particle size d10 ranging from 24 μm to 44 μm, preferably from 30 μm to 38 μm, a mean particle size d50 ranging from 50 μm to 75 μm, preferably from 55 μm to 70 μm, a mean particle size d90 I ranging from 85 μm to 115 μm, preferably from 95 μm to 110 μm, and a mean particle size d99 of at most 160 μm, preferably lower than 150 μm.

According to a second embodiment, the powder composition I comprises additives some of which are not embedded in the polyolefinic matrix C. According to this embodiment, the powder composition I has advantageously a mean particle size d10 ranging from 20 μm to 50 μm, a mean particle size d50 ranging from 50 μm to 80 μm, a mean particle size d90 ranging from 80 μm to 120 μm, and a mean particle size d99 of at most 160 μm.

Advantageously, the powder composition I according to the invention has an increased processing window, a higher elongation at break, an improved tensile modulus, an improved tensile strength, and an increased izod impact, compared to the corresponding powder composition without nanoparticles A and particles B.

Process of Preparation of the Powder Composition

The invention further relates to the process of preparation of the powder composition I according to the invention. This process of preparation comprises the following steps:
a) Providing a polyolefinic matrix C, nanoparticles A and particles B, the polyolefinic matrix C, nanoparticles A and particles B being as defined above,
b) Melting the polyolefinic matrix C,
c) Mixing the melted polyolefinic matrix with particles B,
d) Powdering the resulting mixture to obtain a polyolefinic powder II in which particles B are embedded in the polyolefinic matrix C,
e) Mixing nanoparticles A with the polyolefinic powder II,
f) Sieving to obtain the powder composition I.

Preferably, steps a) to c) are performed in an extruder, preferably a twin screw extruder. Typically, one may use a 30 L/D or more twin screw extruder. The extruder may be divided in several thermo-controlled or heating zones, a converging zone and a die.

During step b), the polyolefinic matrix C is melted. This can be performed by introducing the polyolefinic matrix C in a first thermo-controlled zone of the extruder, named Z0. In the subsequent thermo-controlled zone ZA, constituted eventually by several heating blocks, the polyolefinic matrix C may be heated and mixed. The temperature of the thermocontrolled zone ZA is preferably at least 30° C. superior to the melting peak temperature of the polyolefin. After that, there is advantageously a decompression to allow the introduction of other components in the extruder.

During step c), the melted polyolefinic matrix is mixed with particles B. For that purpose, particles B may be added in a subsequent thermo-controlled zone ZB via a feeder. In this subsequent thermo-controlled zone ZB, the temperature is preferably above the melting peak temperature of the polyolefin. Then, the melted polyolefinic matrix and particles B are mixed during a time that is sufficient to disperse homogeneously particles B in the melted polyolefinic matrix in a subsequent thermo-controlled zone ZC. Preferably after that, a decompression is applied and the mixture is mixed again in a subsequent thermo-controlled zone ZD.

Optionally, additives may be added during step c). The nature and amount of these additives are as detailed above. According to this embodiment, particles B and additives may be added to the melted polyolefinic matrix simultaneously or one after the other in any order. Preferably, particles B and additives are added simultaneously to the melted polyolefinic matrix.

Step d) may be carried out outside the extruder. During this step, the resulting mixture of polyolefinic matrix, particles B and optional additives is powdered to afford the polyolefinic powder II as defined above. For example, this may be performed by cryo grinding.

Then during step e), nanoparticles A are mixed or dry blended with the polyolefinic powder II. A final sieving step (step f)) affords the powder composition I.

Optionally, additives may be added during step e). The nature and amount of these additives are as detailed above. According to this embodiment, nanoparticles A and additives may be added to the polyolefinic powder II simultaneously or one after the other in any order. Preferably, nanoparticles A and additives are added simultaneously to the polyolefinic powder II.

According to a particular embodiment, the process of preparation of a powder composition I according to the invention comprises at least one, and in particular one, additional step g) that is carried out after step d) and/or step e) and/or step f). This optional step g) consists in a post treatment in order to improve the properties of the powder composition I, e.g. to improve the sphericity of the powder. Rounding particles, mechanical and/or thermal treatment, air classification, oxidation, surface coating may be cited as possible post treatments.

Three-Dimensional Article and Method of Preparation

The invention further relates to a 3D printed article made from the powder composition I as defined above, or from the powder composition I obtained from the process described above.

In the context of the invention, a 3D printed article refers to an object built by a 3D printing system, such as SLS or MJF for example.

Finally, the invention relates to a method for preparing a 3D printed article. Several additive methods may be used, among which selective laser sintering (SLS) and multi-jet fusion (MJF) techniques are particularly preferred.

The SLS technique implies the formation of superimposed layers that are bonded together by repeating the following two steps:
a) depositing a continuous bed of powder composition I comprising or exclusively constituted by the powder composition I as defined in the context of the invention, on a platform or on a previously consolidated layer;
b) carrying out a localized consolidation of a portion of the deposited powder composition I by applying a laser beam in accordance with a predetermined pattern for each layer and simultaneously bonding the layer that has been formed thereby to the preceding consolidated layer if present, in a manner such as to cause the desired three-dimensional shape of the 3D article to grow progressively.

Advantageously, the continuous bed of powder composition of step a) has a constant thickness and extends as a surface above the section of the desired 3D article taken at the level of the layer, in order to guarantee precision at the ends of the article. The thickness of the bed of powder is advantageously in the range 40 μm to 120 μm.

The consolidation of step b) is carried out by laser treatment. To this end, it is possible to use any SLS printing machine that is known to the person skilled in the art such as for example a 3D printer of the SnowWhite type from Sharebot, of the Vanguard HS type from 3D Systems, of the Formiga P396 type from EOS, of the Promaker P1000 type from Prodways or of Formiga P110 type from EOS.

The parameters of the SLS printing machine are selected in a manner such that the surface temperature of the bed of powder composition is in the sintering range, i.e. comprised between the offset crystallization temperature and the onset fusion temperature.

The MJF technique implies the formation of superimposed layers that are bonded together by repeating the following steps:
a) depositing a continuous bed of powder composition I comprising or exclusively constituted by the powder composition I as defined in the context of the invention, on a platform or on a previously consolidated layer;
b) applying a fusing agent in accordance with a predetermined pattern for each layer,
c) carrying out a localized consolidation of a portion of the deposited powder composition I by application of energy.

The MJF process may also comprise the application of a detailing agent.

Fusing agents and detailing agents that may be used according to the invention are those commonly used in the art.

The invention will now be further illustrated by the following examples that are for illustrative purpose only.

### EXAMPLES

### Example 1: Preparation of Polyolefinic Powders

A polyolefinic powder II.1 according to the invention and a polyolefinic powder 11.2 outside the invention having the formula detailed in table 1 below have been prepared (the percentages are weight percentages given relative to the total weight of the polyolefinic powder).

TABLE 1

| | II.1 | II.2 |
|---|---|---|
| | (according to | (outside the |
| | the invention) | invention) |
| Random Propylene copolymer having a | 97.82% | 98.82% |
| melting temperature of 140° C. and a melt | | |
| flow rate of 10-14 g/10 min at 230° C. | | |
| Mixture of antioxydants | 0.67 wt % | 0.67 wt % |
| Co-Crystallazing agent | 0.51 wt % | 0.51 wt % |
| Aluminium oxide nanoparticle (sold under | 1 wt % | 0 wt % |
| the name AEROXIDE ® Alu C 805 by | | |
| EVONIK) | | |

The polyolefinic powders II.1 and 11.2 are prepared as follows.

Polyolefinic powders II.1 and 11.2 are compounded on a 50 L/D twin screw extruder with a screw diameter of 26 mm for lab scale production at 10 to 25 kg/h and on a 32 mm for pilot production (80 to 100 kg/h).

Both twin screw extruders are divided in 10 thermo-controlled zones (Z0 and ZA to ZJ), a converging zone and a die. Strand pelletization was used on the 26 mm diameter extruder, and underwater pelletizing system was used on the 32 mm diameter extruder. In each case, the screw profile is the same. The polypropylene is introduced first in the first thermo-controlled zone Z0 of the extruder. A first mixing sequence is carried out by melting the polypropylene in a second thermo-controlled zone ZA comprising heating blocks Z1 and Z2, after that a decompression is performed to allow the introduction of the additives via a side feeder in a heating block Z3 of a subsequent thermo-controlled zone ZB. The components are then mixed in a long mixing sequence in heating blocks Z4 to Z7 of zone ZB, then a decompression is applied followed by a small mixing sequence in heating blocks Z8 and Z9 of ZB and the pumping zone before the die. The temperature profile is as follows: Z0 10-40° C./Z1-Z2 230° C./Z3-Z9 180° C./Diverter valve 180° C./Die 180° C. -The screw speed ranges from 300 to 450 RPM.

After the extruder, the mixture is cryo grinded to afford the polyolefinic powder.

The cryo grinding is performed using a pin mill GSM 250 manufactured by Gotic GmbH. The miller is fed by a cooling screw and has a diameter of 250 mm with potentially 3 rings of pins (250 pins in total). For these two polyolefinic powders II.1 and 11.2, the same configuration of pin disc is used. The temperature is regulated at −45° C. with a thermocouple in the milling unit and the speed disc is set at 8900 RPM. After the milling units, sieving allows for separation of the powder of dimension under 90 μm which is collected from the 90 μm oversize which are incorporated in the cooling screw to be milled again. The sieving unit is a nutation siever with a double screen, and the sieve has a mesh of 90×90 μm. To avoid the clogging on the sieve, it is equipped with an ultrasonic system and elastomeric balls under the sieve.

Polyolefinic powder 11.2. is prepared according to this procedure. The polyolefinic powder II.1 is prepared according to the same procedure that the polyolefinic powder 11.2 except that 1% of aluminium oxide nanoparticules is added. This filler is introduced via a side feeder in Z3 with the other additives. The replacement of 1% of the polypropylene by 1% of aluminium oxide nanoparticles doesn't change the process and no significant change in the processing parameters was observed.

The particle size distributions of the polyolefinic powders II.1 and 11.2 are similar, as shown in table 2 below. The particle size distributions were measured with a Mastersizer 3000 sold by Malvern.

TABLE 2

| | Particle size distribution | | | |
|---|---|---|---|---|
| | D10 (μm) | D50 (μm) | D90 (μm) | D99 (μm) |
| polyolefinic powder II.1 | 35.9 | 65.8 | 109 | 149 |
| polyolefinic powder II.2 | 34.5 | 64.2 | 108 | 149 |

### Example 2: Preparation of Powder Compositions

The polyolefinic powders II.1 and 11.2 were used to prepare the following powder compositions listed in table 3 below. The percentages given in this table 3 are weight percentages relative to the total weight of the powder composition.

TABLE 3

| | Polyolefinic | |
|---|---|---|
| Powder composition | powder | Flow aid |
| I.1 (according | 99.9 wt % | 0.1 wt % of aluminium oxide |
| to the | of II.1 | nanoparticles (AEROXIDE ® |
| invention) | | AluC 805 sold by EVONIK) |
| I.2 (outside | 99.9 wt % | 0.1 wt % of aluminium oxide |
| the invention) | of II.2 | nanoparticles (AEROXIDE ® |
| | | AluC 805 sold by EVONIK) |
| I.3 (outside | 99.55 wt % | 0.45 wt % of mixture of silica |
| the invention) | of II.2 | microparticles and |
| | | nanoparticles |

Powder composition I.1 is according to the invention since it comprises aluminium oxide nanoparticles both embedded in the polyolefinic matrix and mixed with the polyolefinic powder.

Powder composition I.2 is outside the invention since there is no metal, nitride, carbide or metal oxide micro or nanoparticles embedded in the polyolefinic matrix.

Powder composition I.3 is outside the invention since there is no metal, nitride, carbide or metal oxide micro or nanoparticles embedded in the polyolefinic matrix.

Powder compositions I.1 to I.3 were prepared by adding the flow aid to the polyolefinic powder, mixing with a rapid mixer “Caccia Turbomelangeur serie AV0600B” and then sieving with a vibrating sievier “Sodeva Tamiseur SC12” with ultrasonic system and a screen with a 90 μm square mesh.

The particle size distribution of the three powder compositions were evaluated and are reported in table 4. The particle size distribution was measured according to the procedure mentioned above.

TABLE 4

| | Particle size distribution | | | |
|---|---|---|---|---|
| | d10 (μm) | d50 (μm) | d90 (μm) | d99 (μm) |
| Powder composition I.1 | 33.8 | 61.6 | 102 | 138 |
| Powder composition I.2 | 30.2 | 58.1 | 98.5 | 135.0 |
| Powder compostion I.3 | 34.4 | 62.0 | 101.5 | 137.2 |

No significant changes in the particle size distribution can be noticed. The particle size seems to be slightly higher in powder composition I.1.

The powder bed density (ρ₀), the tap density (p∞) and the speed of compaction (n_{1/2}) were also evaluated with the GranuPack device from GranuTools™ (see table 5).

TABLE 5

| Powder | p(0) | p(n) | n_{1/2} | H(n) | p(∞) |
|---|---|---|---|---|---|
| composition | [g/cm³] | [g/cm³] | [Ø] | [Ø] | [g/cm³] |
| I.1 | 0.298 | 0.357 | 17.9 | 1.197 | 0.371 |
| I.2 | 0.291 | 0.342 | 15.9 | 1.175 | 0.354 |
| I.3 | 0.301 | 0.361 | 16.9 | 1.199 | 0.375 |

As shown in table 5, powder composition I.1 has a similar powder bed density (p₀), tap density (ρ∞) and speed of compaction (n_{1/2}) in spite of a lower flow aid and filler contents. Thus, the flowability of powder composition is satisfactory.

### Example 3: Printing of Powder Compositions

Powder composition I.1 was printed using SLS and MJF techniques. In both cases, a satisfactory 3D printed article was obtained.

Printing with SLS Printer

Dumbbells were printed on Prodway Promaker P1000 SLS printer. The printing conditions were:
power bed surface temperature: 130-133° C.,
piston temperature: 125° C.,
hatching distance: 0.14 mm,
laser power: 9.8-14 W,
laser scan speed: 3500 mm/s.

The mechanical properties of the 3D printed dumbells were evaluated and are reported in table 6 below. Modulus and Elongation at break were measured with ZWICK/Roell® Z005 tensiometer (Zwick GmbH, Germany) according to respectively ISO 527-1 and 2 standard. Resilience was measured with ZWICK/Roell® Charpy 255 pendulum impact tester, and Charpy Notched and unnotched Impact is measurable according to ISO 179-1 standard. Notably, ASTM and ISO testing protocols herein are based on the most recent publication as of the date of filing of the present application.

TABLE 6

| | | | | Charpy |
|---|---|---|---|---|
| | E | σr | εr | unnotched |
| Powder composition | [MPa] | [MPa] | [%] | (kJ/m²) |
| I.1 (according to | 1350 | 27,2 | 18 | 27 |
| the invention) | | | | |
| I.2 (outside to | 1325 | 26,4 | 16 | 22 |
| the invention) | | | | |
| I.3 (outside the | 1320 | 26,9 | 15 | 21 |
| invention) | | | | |

There is no significant difference measured on the modulus.

There is a real improvement on the elongation at break and on the resilience using the powder composition I.1 according to the invention compared to powder compositions I.2 and 1.3 outside the invention.

MJF Printing

A series of 3D articles were printed using a Multi JetFusion printer system that included fluid applicators for jetting a fusing agent and a detailing agent onto the particulate build material.
The printing parameters were:
powder surface temperature 114° C.,
spread powder temperature 80° C.,
trolley left/right wall temperature 100° C.,
fuse lamp trailing (Power) 5600.

After printing, the 3D articles were analyzed for mechanical properties including elongation (strain) at break, tensile modulus, tensile strength, Charpy Notched and unnotched Impact.

The tensile modulus, tensile strength, and elongation at break were measured with ZWICK/Roell® Z005 tensiometer (Zwick GmbH, Germany) according to respectively ISO 527-1 and 2 standard. Resilience was measured with ZWICK/Roell® Charpy 255 pendulum impact tester, and Charpy Notched and unnotched Impact is measurable according to ISO 179-1 standard.

The test results are shown in table 7. Three 3D articles were measured for these properties, and the values in the table are the average of the three measurements.

TABLE 7

| | Powder | | Powder | | Powder | |
|---|---|---|---|---|---|---|
| | composition | | composition | | composition | |
| | I.1 | | I.2 | | I.3 | |
| Elongation at Break | 21% | | 19% | | 16% | |
| Tensile Modulus | 1420 | MPa | 1310 | MPa | 1270 | MPa |
| Tensile strength | 30.0 | MPa | 27.2 | MPa | 26.3 | MPa |
| Charpy Notched Impact | 2.5 | kJ/m² | 2.1 | kJ/m² | 1.70 | kJ/m² |
| Charpy UnNotched | 31.2 | kJ/m² | 25.0 | kJ/m² | 21.3 | kJ/m² |

Impact

These results show a slight increase in tensile modulus, the tensile strength is also significatively increased. The major improvement concerns the elongation at break, and Charpy Notched and unnotched Impact. The addition of Al₂O₃ in the compound and as a flow aid (composition I.1) had more effect than only as a flow aid (composition I.2).

In both cases (printed by SLS or by MJF), the consolidated powder composition may be reused, in combination with new powder composition, to prepare another 3D printed article.

1.-14. (canceled)

15. A powder composition (I) comprising nanoparticles (A) blended with a polyolefinic powder (II), said polyolefinic powder (II) containing particles (B) embedded in a polyolefinic matrix (C), nanoparticles (A) being metal or metal oxide nanoparticles and particles (B) being metal, nitride, carbide or metal oxide micro or nanoparticles, said powder composition (I) containing at least 90 wt % of polyolefinic matrix (C) relative to the total weight of the powder composition (I), characterized in that polyolefinic matrix (C) is a copolymer of polyethylene or polypropylene with 1 wt % to 8 wt % of ethylene or 1-butene relative to the total weight of the polyolefinic matrix (C).

16. A powder composition (I) according to claim 15 wherein the particles (B) are present in an amount ranging from 0.2 wt % to 9 wt % relative to the total weight of the powder composition (I).

17. A powder composition (I) according to claim 15 wherein nanoparticles (A) are present in an amount ranging from 0.05 wt % to 0.5 wt % relative to the total weight of the powder composition (I).

18. A powder composition (I) according to claim 15 wherein nanoparticles (A) contain aluminium oxide, zinc oxide, silicon dioxide, copper oxide, titanium dioxide, or silver.

19. A powder composition (I) according to claim 15 wherein particles (B) contain aluminium oxide, aluminium nitride, zinc oxide, silicon dioxide, silicon carbide, boron nitride, iron carbide, copper oxide, titanium dioxide, or silver.

20. A powder composition (I) according to claim 15 wherein nanoparticles (A) and particles (B) are the same.

21. A powder composition (I) according to claim 15 further comprising anti-oxidants; fillers of different nature than particles (B) and nanoparticles (A) such as for example glass beads, fibers or mineral fillers; anti nucleating agents; co-crystallizers; plasticizers; dyes; antistatic agents; waxes; compatibilizers such as maleic anhydride grafted polymer powder; polymer powders other than the polyolefin such as polyamide or polyester powder.

22. A process of preparation of the powder composition (I) according to claim 15 comprising the following steps:
a) Providing a polyolefinic matrix (C), nanoparticles (A) and particles (B), the nanoparticles (A) being metal or metal oxide nanoparticles and the particles (B) being metal, nitride, carbide or metal oxide micro or nanoparticles, the polyolefinic matrix (C) being a copolymer of polyethylene or polypropylene with 1 wt % to 8 wt % of ethylene or 1-butene relative to the total weight of the polyolefinic matrix (C),
b) Melting the polyolefinic matrix (C),
c) Mixing the melted polyolefinic matrix with particles (B),
d) Powdering the resulting mixture to obtain a polyolefinic powder (II) in which particles (B) are embedded in the polyolefinic matrix (C),
e) Mixing nanoparticles (A) with the polyolefinic powder (II),
f) Sieving to obtain the powder composition (I).

23. The process according to claim 22 wherein anti-oxidants; fillers of different nature than particles (B) and nanoparticles (A) such as for example glass beads, fibers or mineral fillers; anti nucleating agent; co-crystallizers; polymers other than polyolefin such as polyester or polyamide; plasticizers; dyes; antistatic agents; waxes, compatibilizers such as maleic anhydride grafted polymer powder; and/or polymer powders such as polyamide or polyester powder are added at step c) and/or at step e), simultaneously or one after the other in any order.

24. The process according to claim 22 comprising at least one step g) carried out after step d) and/or step e) and/or step f) of oxidation, mechanical treatment, thermal treatment, surface coating, rounding particles, and/or air classification.

25. The process according to claim 22 wherein steps a) to c) are carried out in an extruder.

26. A three-dimensional printed article made from the powder composition (I) according to claim 15.

27. A three-dimensional printed article made from the powder composition (I) obtained according to the process as claimed in claim 22.

28. A method for preparing a three-dimensional printed article according to claim 26 using the selective laser sintering or the multi jet fusion technique.

29. A method for manufacturing a three-dimensional printed article comprising the powder composition (I) according to claim 15.

30. A method for manufacturing a three-dimensional printed article comprising the powder composition (I) obtained according to a process as claimed in claim 22.
